(19) United States
(12) Patent Application Publication
(10) Pub. No.: US 2015/0012325 A1
(43) Pub. Date: Jan. 8, 2015

(54) SOCIAL MEDIA AND E-COMMERCE FILM PLANNING SYSTEM AND PROCESS

(71) Applicant: STEPHANIE LYNN MAHER, RESEDA, CA (US)

(72) Inventor: STEPHANIE LYNN MAHER, RESEDA, CA (US)

(21) Appl. No.: 14/324,964

(22) Filed: Jul. 7, 2014

Related U.S. Application Data
(60) Provisional application No. 61/843,770, filed on Jul. 8, 2013.

(51) Int. Cl. G06Q 10/06

(52) U.S. Cl. CPC G06Q 10/06313
USPC 705/7.23

(57) ABSTRACT

A system and a process are disclosed which utilize social media and e-commerce for film/TV breakdown (itemization, organization, cross-sectional look book) services for users to plan a film, with auto posting to an internal e-commerce module, mail merge documents and social media communication. The system incorporates the ease of e-commerce, visual design and social media with mail-merge documentation, scheduling and time management for overall better organization at a cheaper operating price. The system allows multiple productions simultaneously by one user, allows instant access to an internal trade site with other users, and allows for auto e-commerce of items at remote shooting locations. The system shares input from all department heads and allows those department heads to be assigned tasks usually handled only by a producer. The system also allows the to assign breakdown responsibilities to department heads.

### CLAIM OF BENEFIT TO PRIOR APPLICATION

This application claims benefit to U.S. Provisional Patent Application 61/843,770, entitled “A website that transforms data from written documents into breakdown sheet templates which itemize sheets per scene in a film/video/TV production, and which upload items to a swap site with one click to change item status, converts to a pinboard/library template shared with other filmmakers on line before, during and after a production,” filed Jul. 8, 2013. The U.S. Provisional Patent Application 61/843,770 is incorporated herein by reference.

### BACKGROUND

Embodiments of the invention described in this specification relate generally to video and film production, and more particularly, to video and film production planning systems.

Current standards for planning and organizing productions by low budget and independent (non-studio) filmmakers are based on software installation that connects computer terminals within a closed intranet system, or limits on-line users to expensive websites that focus exclusively on scheduling, budgeting, location scouting, casting and/or personal agents. These sites and software applications cater to the producer or unit production manager (UPM or “line producer”) and do not incorporate other department heads in the planning process.

In addition, traditional script breakdown not performed visually and is limited to a producer or UPM and does not allow for budgeted or breakdown items to auto-post to trade-sites. Thus, existing software does not combine the look book visual design of a film with script breakdowns. However, in film and video productions, if a user wants to create a visual image, certain equipment/cast/sets/items/supplies are needed. For example, to shoot in the desert, a camel and an animal wrangler may be needed. However, this is difficult to find during pre-production and can set back a production schedule in undesirable ways.

Therefore, what is needed is a new means of providing low budget and independent (non-studio) filmmakers a better way to plan and organize their productions in a way that incorporates other department heads in the planning process and which provides a variety of automated and time saving planning tools for allocating and obtaining production resources.

### BRIEF DESCRIPTION

Some embodiments of the invention include a novel film and video production planning process and system that utilizes social media and e-commerce. In some embodiments, the film and video production planning system incorporates the ease of e-commerce, visual design, and social media with mail-merge documentation, scheduling and time management for overall better organization at a cheaper operating price. In some embodiments, the film and video production planning system allows multiple simultaneous productions to be planned by a single user. In some embodiments, the film and video production planning system allows instant access to an internal trade site with other users, allows for auto e-commerce of items at remote shooting locations, does not limit the user to “per installation”, or burden them with heavy cost. In some embodiments, the film and video production planning system shares input from all department heads and allows the department heads to be assigned tasks usually handled only by a unit production manager (UPM).

In some embodiments, the film and video production planning system sets each invited user's role in the production and controls sharing of information according to the specifications of a producer who initiates use of the system for one or more productions. In some embodiments, the film and video production planning system allows the producer to assign breakdown responsibilities to new department heads. When needed, this allows the producer to have better control of all production elements and allows the producer to re-define the individual role of each department or crew member.

In some embodiments, the film and video production planning process utilizes social media and e-commerce in the production of one or more of a film, a video, and a television production. In some embodiments, the film and video production planning process comprises a set of initialization steps, a set of planning steps, a set of social collaboration steps, a set of production steps, and a set of post-production steps.

In some embodiments, the set of initialization steps comprises creating a producer user account and creating a production project associated with the producer. In some embodiments, the set of planning steps comprises itemizing a set of elements associated with a screenplay for the project and creating a budget with a set of budget items that correspond to the set of elements.

In some embodiments, the set of social collaboration steps comprises inviting others to join the production as production users and using a collaborative visual tool to plan production around the invited production users. In some embodiments, the set of production steps comprises posting the itemized elements to an e-commerce module, and creating schedules, contracts, and other production documents. In some embodiments, the set of post-production steps comprises updating each item in the e-commerce module when the item is changed and generating a pitch package based on the collaborative visual tool.

The preceding Summary is intended to serve as a brief introduction to some embodiments of the invention. It is not meant to be an introduction or overview of all inventive subject matter disclosed in this specification. The Detailed Description that follows and the Drawings that are referred to in the Detailed Description will further describe the embodiments described in the Summary as well as other embodiments. Accordingly, to understand all the embodiments described by this document, a full review of the Summary, Detailed Description, and Drawings is needed. Moreover, the claimed subject matters are not to be limited by the illustrative details in the Summary, Detailed Description, and Drawings, but rather are to be defined by the appended claims, because the claimed subject matter can be embodied in other specific forms without departing from the spirit of the subject matter.

### BRIEF DESCRIPTION OF THE DRAWINGS

Having described the invention in general terms, reference is now made to the accompanying drawings, which are not necessarily drawn to scale, and wherein:

FIG. 1 conceptually illustrates a film and video production planning process that utilizes social media and e-commerce in some embodiments.

FIG. 2 conceptually illustrates a website interface of a production being planned through use of the film and video production planning system in some embodiments.

FIG. 3 conceptually illustrates a block diagram of data extraction performed by the film and video production planning system in some embodiments.

FIG. 4 conceptually illustrates an example of a breakdown sheet generated by the film and video production planning system in some embodiments.

FIG. 5 conceptually illustrates an example of a trade module for the film and video production planning system in some embodiments.

FIG. 6 conceptually illustrates an electronic system with which some embodiments of the invention are implemented.

### DETAILED DESCRIPTION

In the following detailed description of the invention, numerous details, examples, and embodiments of the invention are described. However, it will be clear and apparent to one skilled in the art that the invention is not limited to the embodiments set forth and that the invention can be adapted for any of several applications.

Some embodiments of the invention include a novel film and video production planning process and system that utilizes social media and e-commerce. In some embodiments, the film and video production planning process utilizes social media and e-commerce in the production of one or more of a film, a video, and a television production.

### I. Film and Video Production Planning Process

In some embodiments, the film and video production planning process comprises a set of initialization steps, a set of planning steps, a set of social collaboration steps, a set of production steps, and a set of post-production steps.

In some embodiments, the set of initialization steps comprises creating a producer user account and creating a production project associated with the producer. In some embodiments, the set of planning steps comprises itemizing a set of elements associated with a screenplay for the project and creating a budget with a set of budget items that correspond to the set of elements. In some embodiments, the set of social collaboration steps comprises inviting others to join the production as production users and using a collaborative visual tool to plan production around the invited production users. In some embodiments, the set of production steps comprises posting the itemized elements to an e-commerce module, and creating schedules, contracts, and other production documents. In some embodiments, the set of post-production steps comprises updating each item in the e-commerce module when the item is changed and generating a pitch package based on the collaborative visual tool.

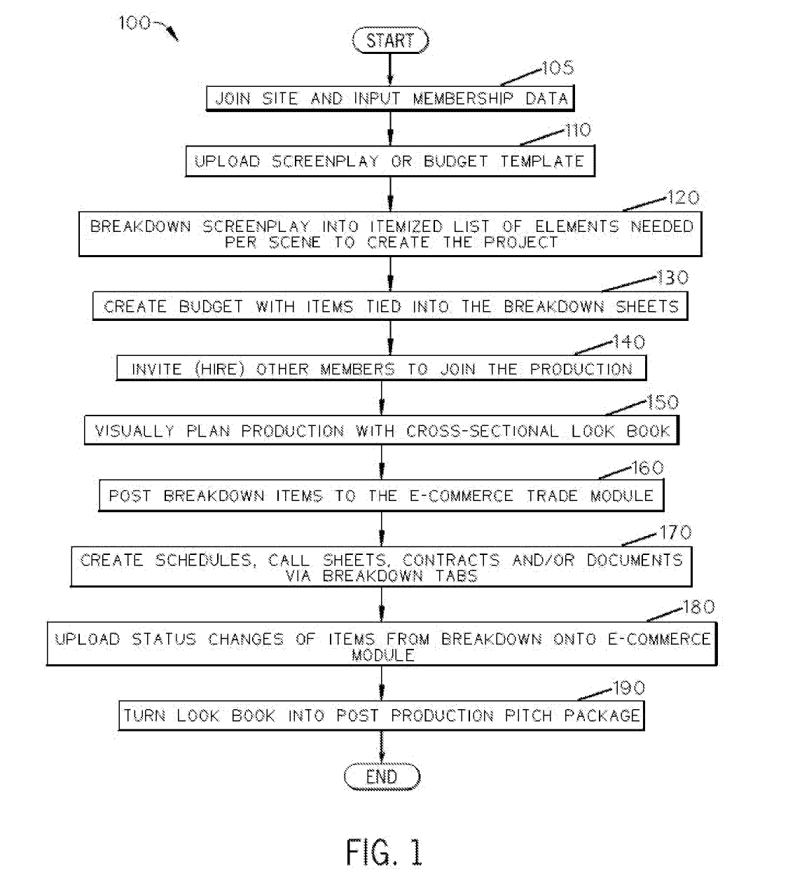

By way of example, FIG. 1 conceptually illustrates a film and video production planning process 100 that utilizes social media and e-commerce. In some embodiments, the film and video production planning process 100 is performed by a film and video production planning software system. In some embodiments, the film and video production planning software system includes a plurality of programs comprising a client program and a server program. In some embodiments, the server program is accessible as a cloud service over the Internet.

As shown in this figure, the process 100 starts when the a producer begins to initiate the system for a particular production project. The producer may use the client program to access the server program providing the cloud service for the film and video production planning system. Thus, the producer joins a web site that provides an interface for the cloud service of the film and video production planning system. At this step, the process 100 receives (at 105) the membership data input by the producer and creates a producer user account based on the received membership data. Next, the producer uploads a screenplay or budget template to establish a new project in the system. At this step, the process 100 receives (at 110) the initial screenplay or budget template and creates a production project that is associated with the producer user account.

The process 100 of some embodiments next performs the set of planning steps. In these steps, the producer selects a set of screenplay items to breakdown the screenplay into elements for each scene. The process creates an itemized list of the elements needed per scene based on this breakdown and then creates (at 120) the project. Next, the process creates (at 130) a budget with a set of budget items that correspond to the set of elements. In some embodiments, the process creates the budget from the budget template, if the producer uploaded one, and fills out the budget with the set of budget items which correspond to the set of screenplay elements.

Next, the process 100 of some embodiments transitions into the set of social collaboration steps, allowing the producer to interface with the program to invite (at 140) other members to join the production. For each invited member who joins, the process 100 creates a production user account that is tied to the production. At some point after one or more production user accounts are created, the producer may use a collaborative visual tool to plan the production with the invited production users being assigned production roles. The process 100 of some embodiments sets production permissions for each invited user which constrain the user's role in the production and controls the user's sharing of information as the producer wishes.

In some embodiments, the producer uses a cross-sectional look book of invited production users. The look book is a cross-sectional visual look at production items and roles spanning the production (i.e., is cross-sectional). The look book may include, for each scene with visual reference, one or more of layout images, scene design items, lighting configurations, story boards, wardrobe details, etc., as well as locations, vertical or horizontal linear comparisons of scenes (e.g., to avoid continuity mistakes, visual inaccuracies, and/or other errors in order to better plan the image and story). In some embodiments, the process generates the look book after the invited production users are entered into the system and assigned roles.

In some embodiments, the set of production steps are started by the process 100 posting (at 160) the itemized elements to an e-commerce module. In some embodiments, the process posts the breakdown items and/or items listed in the budget template to the e-commerce trade module, where the producer can trade, sell, and/or acquire needed items for the production. Expedited matching of items and services is provided by creating wish-lists which can be automatically matched to advertised vendors/services and items with the needs of the producer/user who is seeking such items or services for the production. Also, this allows the producer to share the look book and breakdowns with other invited members who are working on the production. In some embodiments, the film and video production planning system allows individual department heads to create their own look books for their specific role(s) (i.e., wardrobe makes a look book to visually plan all wardrobe for the film, while cinematographer makes look book for lighting per scene, and production design does same with set design per scene). Once the look books are shared with production users, they can be compared.

The process then uses breakdown tabs (at 170) to create schedules, contracts, and other production documents. In some embodiments, the process transitions to the set of post-production steps by listening for production change events that are triggered in the system. For instance, a budget item or screenplay element may change in some manner as directed by the producer, which causes a ripple effect of changes to related items in the system. For example, when done breaking down a scene, upload the changed status of the item from breakdown onto e-commerce module, trade it for something needed or purchase music cues, FX mattes, service contracts from dollar downloads throughout pre-production, production, or post-production. Thus, while listening for change events, the process 100 may upload (at 180) each changed or updated item from the breakdown to the e-commerce module.

When the production is finalized, the producer may select an option to compile the production items into a package to use for communicating with others in regards to the production. In that case, the process 100 generates (at 190) a production package based items in the breakdown or a set of breakdown items selected by the producer using the collaborative visual tool. The production package may include electronic or printed hard-copy items, such as itemized breakdown sheets, shooting schedules, calendars, look books, pitch packages, contracts, storyboard templates, printed budgets, and other such production-related items. Then the process 100 ends.

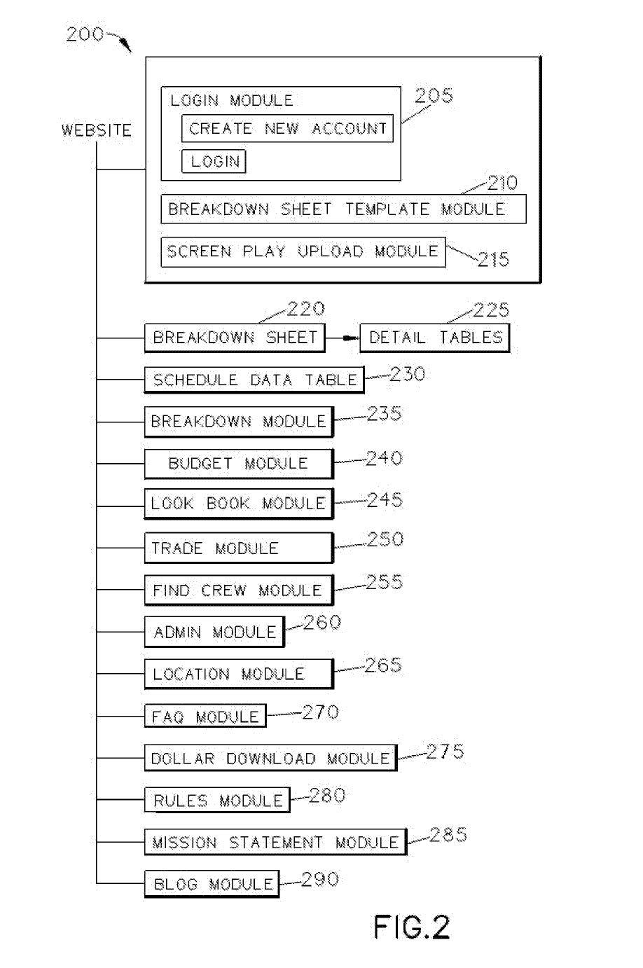

By way of example, FIG. 2 conceptually illustrates a website interface 200 of a production being planned through use of the film and video production planning system. The various elements 205-290 of the website interface 200 are described by reference to the steps performed in the FIG. 1 process 100. The first step 105 of the process 100 relates to using the website interface 200 to obtain a membership through the login module 205. Sign up, provide contact information, start an account. The production user will then have a user account to upload (step 110 of the process 100) and store a screenplay document using the upload module 215, and can breakdown the screenplay (step 120 of the process 100) into it a breakdown sheet 220 by using a breakdown sheet template module 210 and/or a budget (step 130 of process 100) using a budget module 240, and identify elements needed to create the production, such as equipment (using trade module 250), crew (using the find crew module 255), locations (using location module 265), cast, etc. These steps can be done out of sequence, or skipped according to the production needs of the user.

Corresponding to steps 140-160 of the process 100, once the script is broken down, the user contacts employable crew (using the find crew module 255) and posts the breakdown (using the breakdown module 235) and breakdown items/services 225 to acquire or sell/trade off on the e-commerce module (trade module 250) by setting the “have/need/lose” status of a breakdown item, visually plans the end product with a look book design (using look book module 245). These are done by the producer, or any department headed invited onto the production and assigned to a task. Producers/dept heads may use membership database to locate employees, generate service contracts, send electronic communication with the ease of social media. The website interface 200 is designed to allow departmental heads to create their own look book rather than leaving all planning control in the hands of the line producer/UPM. This expedites creative planning, and allows users to keep a record of individual contribution, as well as more effectively compare visual notes as needed. Users also post notes on look book photos to compare notes.

Corresponding to steps 170-190, the department heads, UPM, or producer can create schedule data tables 230, call sheets, contracts or documents via breakdown tabs, send or print them for others working on the production, and when done breaking down a scene, the user can upload the status of the item from the breakdown sheet 220 using the breakdown module 235 to e-commerce (trade) module 250. This allows users to trade/sell used resources for other resources as needed through out the production. Examples of resources that may be needed include any item, equipment, or props needed to shoot a scene. Once the scene is done shooting, producer/UPM/Dept head can change the status of the item on the e-commerce site using the admin module 260 and get rid of it in favor of acquiring something else for other scenes not yet shot. This expedites the shooting process by allowing users to acquire needed items or get rid of unneeded items or services as they continue to shoot the production. This can be done with movies or on-going TV shows. Once done with shooting, users in post-production phase can purchase music cues, FX mattes, service contracts from dollar download module 275 as needed throughout.

Other elements of the website interface 200 include a FAQ module 270 with a list of frequently asked questions, and corresponding answers, a rules module 280 that allows a producer or department head to define a custom operation for allocating, finding, trading, and/or obtaining a specific item, or to perform a custom breakdown operation (e.g., not from a breakdown template or based on multiple screenplays, etc.). The website interface 200 may also include a mission statement module 285 and blog module 290 for posting information related to the production.

Thus, by using the website interface 200, the producer or another production user (such as a department head) may initiate one or more of the operations performed by the process 100. However, the producer still retains overall control of the production, since each production user or department head will have a set of permissions which constrain the user account's ability to perform production operations, as determined by the producer. Also, production users can use the website interface 200 to individually post items or services to sell/trade to other filmmakers independently of a production. Non-production users, such as vendors, can buy paid ads that match item searches on the e-commerce site. This expedited resource matching provides time savings, cash savings, and better networking

### II. Film and Video Production Planning System

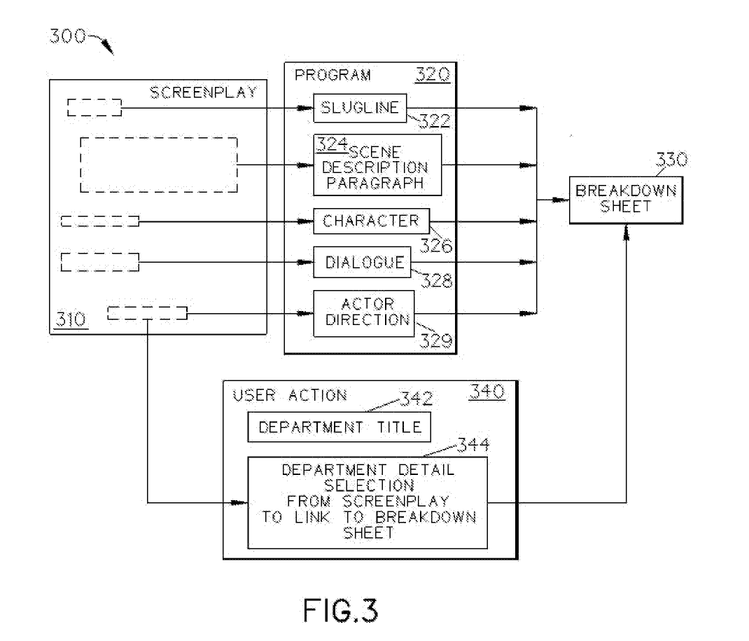

By way of example, FIG. 3 conceptually illustrates a block diagram of data extraction performed by a program of the film and video production planning system 300. As shown in this figure, the data extraction is performed to fill out a script breakdown sheet 330 for the project based on a screenplay 310 that includes a set of screenplay elements (shown as dashed lines within the screenplay 310 block). By using the film and video production planning system, the producer can assign breakdown responsibilities to any department head as desired. Typically, such breakdown responsibilities are assigned only to the UPM, which unnecessarily constrains the collaborative abilities of production members (specifically, department heads) whose improved contributions would otherwise be lost. However, the producer using the film and video production planning system of the present disclosure is not so constrained and can assign breakdown duties to new department heads as needed. This allows better control of all production elements and allows producer to re-define as needed the individual role of each department or crew member.

The screenplay elements are extracted by a film and video production program 320 based on user actions 340 of a production user associated with a particular department 342. The production user may be, for example, the head of the department 342 or another human resource of the department 342. The user actions 340 include department detail selections 344 from the screenplay 310 to link to a breakdown sheet 330. The production user performs the user actions 340 by selecting the elements from the screenplay 310. For example, the production user may interface with the production planning project in the system by way of a user interface (UI), such as the website 200 described by reference to FIG. 2. The program 320 receives the user actions 340 and then extracts the selected elements. In this example, the extracted elements include a slugline 322, a scene description paragraph 324, a character 326, dialogue 328, and actor direction 329.

In this way, the film and video production planning system 300 provides an improved approach to production organization and planning by combining unique visual planning tools with established industry standards, thereby allowing a producer to create a shooting plan, have more effective communication among production users, and eliminate potential visual mistakes by visual reference comparison using a cross-sectional look book. Then the user can plan a movie/TV show better and quicker with the one stop shop approach within a contained community.

The producer/user also has greater flexibility in task assignment, and can auto-post breakdown and budget items to a e-commerce module to get what's needed for the production in less time. This can same money by allowing free swaps on the e-commerce site, which allows indie filmmakers to save cash for high end items like camera, grip truck, location, etc. It also matches budget limitations with advertised vendor special deals. The ability of departmental heads to create and cross-compare visual planning with the look book feature maximizes production value for minimal cost and is a new approach to planning within the industry. It allows producers to get stuff, get rid of stuff, get more stuff all within a contained controlled environment, as shooting continues.

The approach also allows department heads to create and compare their own look books, allows other department heads or invited users to post notes on look book entries, allows instant uploading of breakdown items onto an e-commerce trade site, allows for social media type sharing of the above organization tools, allows converting look books into pitch packages to advertise the project or job related duties on said project, allows auto-tie in of breakdown sheets or e-commerce resources with items listed in a budget. Yet, the film and video production planning system manages to centralize key production aspects which only the producer can determine, such as choosing role assignments (e.g., who does what) of production users and department heads for each department. The producer therefore maintains high-level control over productions, which in turn allows greater flexibility for the producer to be “wearing many hats” on limited budget productions.

This angle on film organization (collaborative breakdown services) is a concept not in the market and not represented in current breakdown service websites or software packages. Thus, the film and video production planning system 300 benefits producers and other production users by providing overall better organization at a cheaper operating price for each production. The organizational aspects of the film and video production planning system are exemplified in the breakdown sheet described in the next section.

### III. Examples of Breakdown Sheet and Trade Module

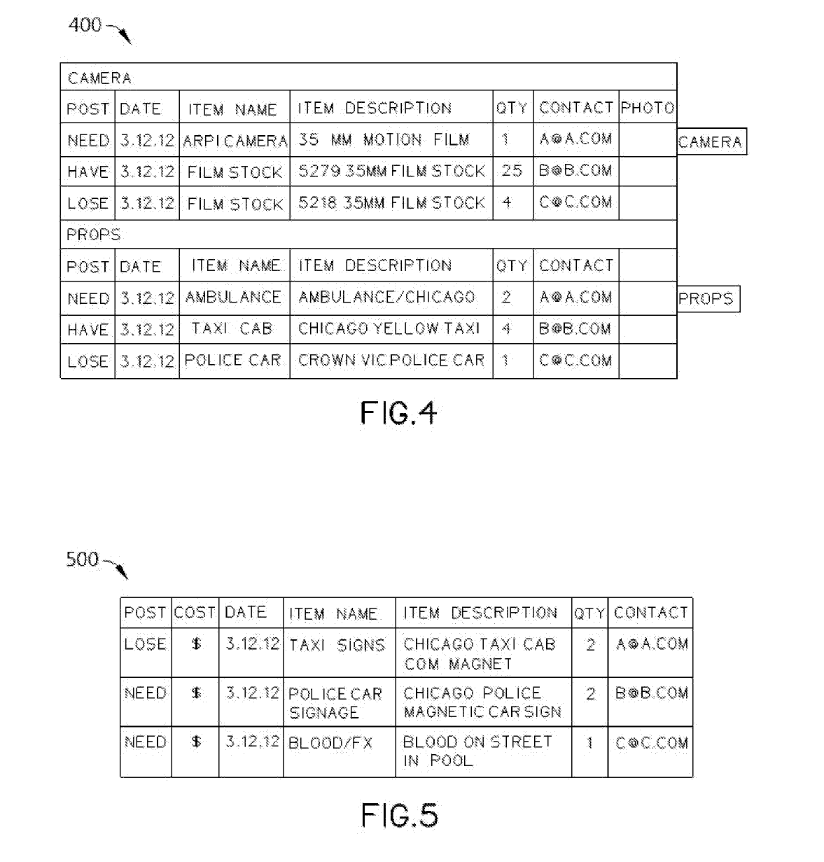

By way of example, FIG. 4 conceptually illustrates an example of a breakdown sheet 400 generated by the film and video production planning system in some embodiments. As shown in this figure, the example breakdown sheet 400 organizes several items related to a particular project. As shown in this figure, “CAMERA” is listed along a top row and “PROPS” is listed along a middle row of the example breakdown sheet 400. Values for status items “POST”, “DATE”, “ITEM NAME”, “ITEM DESCRIPTION”, “QTY”, “CONTACT”, and “PHOTO” are possible in the cells of the breakdown sheet 400. This allows a producer or another production user to quickly identify one or more particular items or elements to be used in the production and its status details.

In addition, the film and video production planning system of some embodiments allows instant access to a trade site with other users, allows for auto e-commerce of items at remote shooting locations, does not limit the user to “per installation”, or burden them with heavy cost. In some embodiments, the film and video production planning system shares input from all department heads and allows the department heads to be assigned tasks usually handled only by a UPM.

By way of example, FIG. 5 conceptually illustrates an example of a trade module 500 for the film and video production planning system. As shown in this figure, the trade module 500 includes columns for status items “POST”, “COST”, “DATE”, “ITEM NAME”, “ITEM DESCRIPTION”, “QTY”, and “CONTACT”. This allows anyone to trade with the producer or department head in order for the production to obtain needed items or elements, or to trade unneeded items or elements where possible.

### IV. Electronic System

Many of the above-described features and applications are implemented as software processes that are specified as a set of instructions recorded on a computer readable storage medium (also referred to as computer readable medium or machine readable medium). When these instructions are executed by one or more processing unit(s) (e.g., one or more processors), they cause the processing unit(s) to perform the actions indicated in the instructions. Examples of computer readable media include, but are not limited to, CD-ROMs, flash drives, RAM chips, hard drives, EPROMs, EEPROMs, etc. The computer readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the invention. In some embodiments, the software programs, when installed to operate on one or more electronic systems, define one or more specific machine implementations that execute and perform the operations of the software programs.

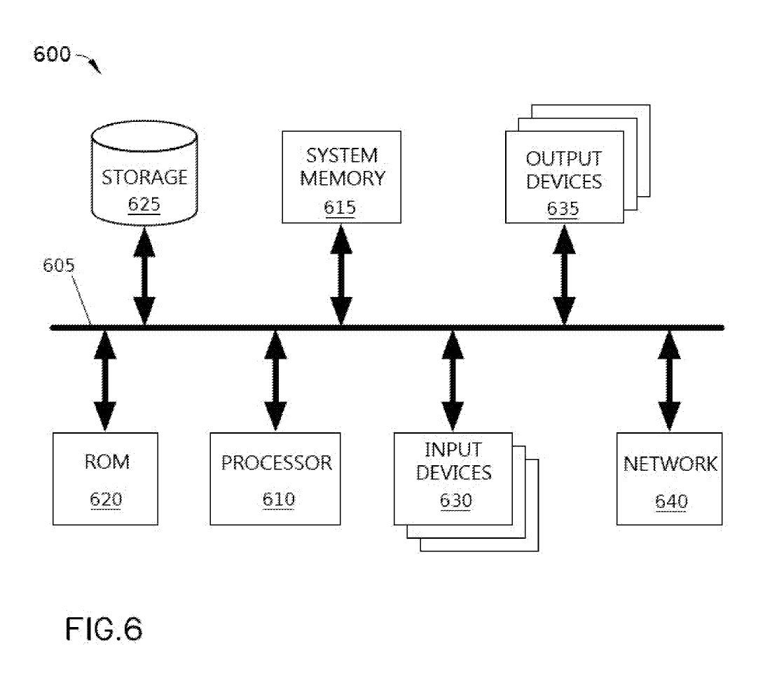

FIG. 6 conceptually illustrates an electronic system 600 with which some embodiments of the invention are implemented. The electronic system 600 may be a computer, phone, PDA, or any other sort of electronic device. Such an electronic system includes various types of computer readable media and interfaces for various other types of computer readable media. Electronic system 600 includes a bus 605, processing unit(s) 610, a system memory 615, a read-only 620, a permanent storage device 625, input devices 630, output devices 635, and a network 640.

The bus 605 collectively represents all system, peripheral, and chipset buses that communicatively connect the numerous internal devices of the electronic system 600. For instance, the bus 605 communicatively connects the processing unit(s) 610 with the read-only 620, the system memory 615, and the permanent storage device 625.

From these various memory units, the processing unit(s) 610 retrieves instructions to execute and data to process in order to execute the processes of the invention. The processing unit(s) may be a single processor or a multi-core processor in different embodiments.

The read-only-memory (ROM) 620 stores static data and instructions that are needed by the processing unit(s) 610 and other modules of the electronic system. The permanent storage device 625, on the other hand, is a read-and-write memory device. This device is a non-volatile memory unit that stores instructions and data even when the electronic system 600 is off. Some embodiments of the invention use a mass-storage device (such as a magnetic or optical disk and its corresponding disk drive) as the permanent storage device 625.

Other embodiments use a removable storage device (such as a floppy disk or a flash drive) as the permanent storage device 625. Like the permanent storage device 625, the system memory 615 is a read-and-write memory device. However, unlike storage device 625, the system memory 615 is a volatile read-and-write memory, such as a random access memory. The system memory 615 stores some of the instructions and data that the processor needs at runtime. In some embodiments, the invention's processes are stored in the system memory 615, the permanent storage device 625, and/or the read-only 620. For example, the various memory units include instructions for processing appearance alterations of displayable characters in accordance with some embodiments. From these various memory units, the processing unit(s) 610 retrieves instructions to execute and data to process in order to execute the processes of some embodiments.

The bus 605 also connects to the input and output devices 630 and 635. The input devices enable the user to communicate information and select commands to the electronic system. The input devices 630 include alphanumeric keyboards and pointing devices (also called “cursor control devices”). The output devices 635 display images generated by the electronic system 600. The output devices 635 include printers and display devices, such as cathode ray tubes (CRT) or liquid crystal displays (LCD). Some embodiments include devices such as a touchscreen that functions as both input and output devices.

Finally, as shown in FIG. 6, bus 605 also couples electronic system 600 to a network 640 through a network adapter (not shown). In this manner, the computer can be a part of a network of computers (such as a local area network (“LAN”), a wide area network (“WAN”), or an Intranet), or a network of networks (such as the Internet). Any or all components of electronic system 600 may be used in conjunction with the invention.

The functions described above can be implemented in digital electronic circuitry, in computer software, firmware or hardware. The techniques can be implemented using one or more computer program products. Programmable processors and computers can be packaged or included in mobile devices. The processes and logic flows may be performed by one or more programmable processors and by one or more set of programmable logic circuitry. General and special purpose computing and storage devices can be interconnected through communication networks.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the invention has been described with reference to numerous specific details, one of ordinary skill in the art will recognize that the invention can be embodied in other specific forms without departing from the spirit of the invention. For example, a process is conceptually illustrated in FIG. 1. The specific operations of this process may not be performed in the exact order shown and described. Specific operations may not be performed in one continuous series of operations, and different specific operations may be performed in different embodiments. Furthermore, the process could be implemented using several sub-processes, or as part of larger macro processes. Thus, one of ordinary skill in the art would understand that the invention is not to be limited by the foregoing illustrative details and examples, but rather is to be defined by the appended claims.

I claim:

1. A non-transitory computer readable medium storing a program which, when executed by at least one processing unit of a computing device, facilitates film and video production planning, said program comprising sets of instructions for:
creating a production planning project associated with a script;
inviting a set of users to join the production planning project;
breaking down the script into an itemized list of script elements;
creating a breakdown sheet comprising the itemized list of script elements;
generating a look book comprising a set of visual production elements associated with producing content for the production planning project;
performing a project resource allocation comprising at least one of posting the breakdown sheet of itemized script elements to a trading forum and creating a wish list of items needed to start producing the content for the production planning project;
creating a set of schedules associated with the production planning project; and
generating a production package after the content is produced for the production planning project.

2. The non-transitory computer readable medium of claim 1, wherein the production package comprises at least one of an itemized breakdown sheet, a shooting schedule, a calendar, a look book, a pitch package, a contract, a storyboard template, and a printed budget.

3. The non-transitory computer readable medium of claim 1, wherein the set of visual production elements comprises at least one of a set of layout images, a set of scene design items, a set of lighting configuration images, a set of story boards, a set of wardrobe details, and a set of location images.

4. The non-transitory computer readable medium of claim 3, wherein the set of visual production elements span the production content associated with the production planning project.

5. The non-transitory computer readable medium of claim 1, wherein the program further comprises a set of instructions for determining whether a change event was triggered by a production user performing at least one of updating an existing element in the itemized list of elements in the breakdown sheet and adding a new element to the itemized list of elements in the breakdown sheet.

6. The non-transitory computer readable medium of claim 1, wherein the program further comprises a set of instructions for receiving a set of production planning project initialization information comprising contact and identity information of a producer for the production, the script, and a budget template.

7. The non-transitory computer readable medium of claim 1, wherein the program further comprises a set of instructions for creating a budget associated with the production planning project.

8. The non-transitory computer readable medium of claim 7, wherein the program further comprises a set of instructions for delegating a set of elements in the itemized list of breakdown sheet elements to a department head production user.

9. A film and video production planning system comprising:
a website interface that allows a production user to interface with a particular production project;
a screenplay with a set of screenplay elements selected for breakdown itemization by the production user;
a data extraction program that extracts the set of screenplay elements from the screenplay, organizes the extracted set of screenplay elements into an itemized list of elements, and creates a breakdown sheet comprising the organized screenplay elements in the itemized list of elements;
a cross-sectional visual tool that creates a look book comprising a visual item for each element in a set of itemized elements in the itemized list of elements; and
a trade module that allows the production user to upload the breakdown sheet with the visual items to a trade forum in order to allocate one or more production resources.

10. The film and video production planning system of claim 9 further comprising a login module that validates login permissions of the production user when the projection user accesses the website.
